(19) United States
(12) Patent Application Publication
(10) Pub. No.: US 2006/0166008 A1
(43) Pub. Date: Jul. 27, 2006

(54) Mouse pad

(76) Inventors: Wei-Tien Hsiao, Hsinchu (TW); Wu-Han Liao, Hsinchu (TW); Ning Yang, Hsinchu (TW); Mao-Shin Liu, Hsinchu (TW); Jhong-Ren Wu, Hsinchu (TW); Chin-Te Huang, Hsinchu (TW); Chang-Chih Hsu, Hsinchu (TW)

Correspondence Address: HARNESS, DICKEY & PIERCE, P.L.C., P.O. BOX 8910, RESTON, VA, 20195, US

(21) Appl. No.: 11/234,219

(22) Filed: Sep. 26, 2005

(30) Foreign Application Priority Data
Jan. 21, 2005 (TW) 94201232

(51) Int. Cl. B32B 17/06

(52) U.S. Cl. 428/427; 428/432

(57) ABSTRACT

A mouse pad is provided, including a glass substrate and a surface layer made from a ceramic material and formed on the glass substrate, wherein the ceramic surface layer has many pores with a surface roughness of 1˜20 μm, such that the ceramic surface layer has a strong resistance to abrasion and deformity. Therefore, the sensitivity of the mouse is maintained and the mouse pad is more durable.

### BACKGROUND

This Non-provisional application claims priority under 35 U.S.C. § 119(a) on Patent Application No(s). 94201232 filed in Taiwan on Jan. 21, 2005, the entire contents of which are hereby incorporated by reference.

1. Field of Invention

This invention relates to a mouse pad, and in particular to a mouse pad having a glass substrate and a surface layer made from a ceramic material.

2. Related Art

A mouse pad is a type of computer accessory and is indispensable for working people. The function of a mouse pad is to provide a smooth surface upon which a mechanical or optical mouse operates, and to reflect the red light radiated from the mouse and therefore to ensure that the mouse works properly. Compared to conventional mechanical mice, optical mice have the advantages of higher sensitivity, greater durability, easier maintenance, and more options for applicable materials. However, not all mouse pads are suitable for optical mice, because an optical mouse works by reflecting a red light off the surface the mouse rests on and a photo-sensor picks up the reflection of that light and uses the information to calculate where the mouse is moving and how far it has moved. Therefore, factors such as the surface roughness of the mouse pad and the material of the mouse pad may affect the use of the optical mouse and further affect the performance of the computer.

The mouse pad used for an optical mouse should have a surface for reflecting light. The conventional mouse pad is usually made directly from high-polymer material, or made by sticking a light-reflective layer on a substrate, or made by forming one or several coats on the substrate of the mouse pad.

Materials used for making the light-reflective layer adhered to the surface of the mouse pad or used for making the mouse pad directly, usually are high-polymer materials. However, although such materials are cheap, they do not have good performance properties and do not have a strong abrasion resistance. Further, high-polymer materials are not dirt-resistant and hard to clean. When people use a mouse, their hands and wrists need to touch the mouse pad, and their hands touch the other parts of their body most often; therefore mouse pads that are easily contaminated by bacteria may be harmful to people's health.

For example, U.S. Pat. No. 4,799,054 discloses a mouse pad having a substrate and an operating layer formed thereon, wherein the operating layer is made from high-polymer materials, such as polyvinyl chloride or polycarbonate. In design for the mouse pad, a sheet made from rubber and a sheet made from a high-polymer material are formed first. Then the two sheets are glued together, and a decorative sheet may be interposed between the two sheets to achieve an aesthetic effect. The idea of this design is to make an operating layer for the mouse pad using high-polymer materials with a high level of hardness and good transparency, in order to reduce abrasion. However, high-polymer materials are often not hard enough, and the surface of the mouse pad may easily get scratches due to abrasion while the mouse is being operated.

U.S. Pat. No. 4,834,502 discloses a mouse pad, having a sheet made from a high-polymer material such as transparent polycarbonate. The interior surface of the sheet has a light-reflective membrane formed by means of lithographic printing, which may facilitate the operation of the mouse. A rubber layer beneath the sheet may prevent the mouse pad from slipping on the desk to thereby make it easy to use. However, because the surface of the mouse pad is made from high-polymer materials, abrasions tend to occur while the mouse is being operated, which may reduce the lifetime of the mouse pad.

Further, several types of mouse pads disclosed in U.S. Pat. No. D365,342, U.S. Pat. No. D376,791, U.S. Pat. No. D388,414, U.S. Pat. No. D399,832, U.S. Pat. No. D399,833, U.S. Pat. No. D415,142, U.S. Pat. No. D423,482, U.S. Pat. No. D432,137, U.S. Pat. No. D447,488, U.S. Pat. No. D453,340, U.S. Pat. No. D453,520, U.S. Pat. No. D453,765, U.S. Pat. No. D462,361, U.S. Pat. No. D462,970, U.S. Pat. No. D466,518 and U.S. Pat. No. D491,575 are made by forming high-polymer materials, metallic materials or rubber, into specific shapes. However, due to limitations of the process technology and consideration of cost, the level of hardness of those materials is usually not high enough. Therefore, surface abrasion becomes the main weakness of those types of mouse pads.

### SUMMARY

In view of the above-mentioned problems, the object of the invention is to provide a mouse pad, having a surface layer made from ceramic material formed on a glass substrate, to improve the abrasion-resistance of the mouse pad and improve the precision of the mouse.

To achieve these and other advantages and in accordance with the purpose of the invention, as embodied and broadly described, a mouse pad has a glass substrate and a surface layer formed on the glass substrate, wherein the surface layer is made from a ceramic material and has many pores with a surface roughness of 1˜20 μm.

The mouse pad according to the invention is made from a glass material to form the substrate, such as to clean more easily. Further, the glass substrate may be tempered glass board or crystallized glass board, such as to have a high level of strength and a longer lifetime. Furthermore, the surface layer made from ceramic material has pores, such that it can easily absorb and eliminate water. Therefore, according to the invention, the mouse pad suits particularly users whose hands often sweat, and is also abrasion-resistant thereby reducing the scratches thereon and damages thereto. Then, the sensitivity of the mouse is maintained and the mouse pad is more durable.

It is to be understood that both the foregoing general description and the following detailed description are exemplary and explanatory and are intended to provide further explanation of the invention as claimed.

### BRIEF DESCRIPTION OF THE DRAWINGS

The patent or application file contains at least one drawing executed in color. Copies of this patent or patent application publication with color drawing will be provided by the Office upon request and payment of the necessary fee.

The invention will become more fully understood from the detailed description given herein below illustration only, and thus are not limitative of the invention, and wherein:

FIG. 1 is a cross-sectional view of a mouse pad according to an exemplary embodiment of the invention.

FIG. 2 is a cross-sectional structure photo of a mouse pad according to an exemplary embodiment of the invention.

FIG. 3 is a graph about the surface roughness Ra.

FIG. 4 is a draw showing an X-ray diffraction analysis of a surface layer according to an exemplary embodiment of the invention.

FIGS. 5-7 depict the results of a test of a mouse that moves on a mouse pad according to an exemplary embodiment of the invention, a fabric mouse pad, and a plastic mouse pad.

FIGS. 8A and 8B are drawings showing the degrees of deformity of a mouse pad according to an exemplary embodiment of the invention before and after the depression.

FIGS. 9A and 9B are drawings showing the degrees of deformity of a plastic mouse pad before and after the depression.

### DETAILED DESCRIPTION

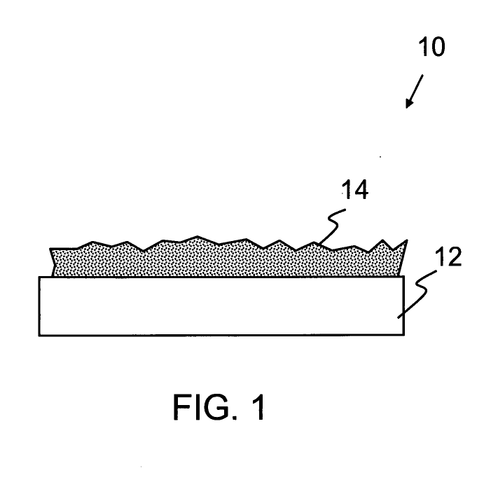

FIG. 1 is a cross-sectional view of a mouse pad according to an exemplary embodiment of the invention.

The mouse pad 10 includes a glass substrate 12 and a surface layer 14 made from a ceramic material formed on the glass substrate 12. The surface layer 14 has a plurality of pores with a surface roughness of 1˜20 μm.

The glass substrate may be tempered glass board or crystallized glass board. The ceramic material, forming the surface layer, may be any combination of oxide, nitride, carbonide, or boride. For example: a ceramic material including aluminum oxide at a concentration of 55˜95 wt % and titanium oxide at a, concentration of 5˜45 wt %. In order to improve the anti-bacteria effect, the surface layer may be made from a ceramic material including aluminum oxide at a concentration of 55˜95 wt % and titanium oxide at a concentration of 5˜45 wt %, and silver or copper at a concentration of 0.01˜3 wt %. The surface layer may also be made from a composite material including both ceramic materials and metallic materials. The thickness of the surface layer may be in the range of 10˜1000 μm, with a porous rate in the range of 2˜15%.

Exemplary embodiments of the invention provide a mouse pad 10 made by means of Thermal Spray Deposition, which is described below.

The ceramic material powder forming the surface layer 14 is comprised of aluminum oxide with a pureness of 99% and a particle diameter between 30 μm˜70 μm and titanium oxide at a concentration of 40 wt %. The ceramic material is sprayed onto the glass substrate 12 by means of the Air Plasma Spray method, with an electric current of 300˜1000 A, a voltage of 20˜100V, and an argon flow of 10˜100 L/min or a hydrogen flow of 1˜30 L/min. The above parameters lead to a surface roughness of the surface layer 12 within the range of 1˜20 μm and a surface layer 14 formed with a plurality of pores. The mouse pad 10 is produced upon the completion of the spray process.

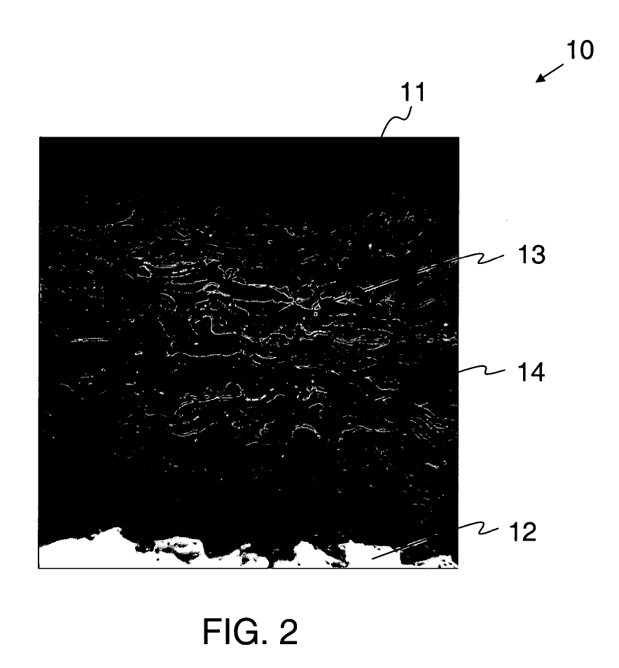

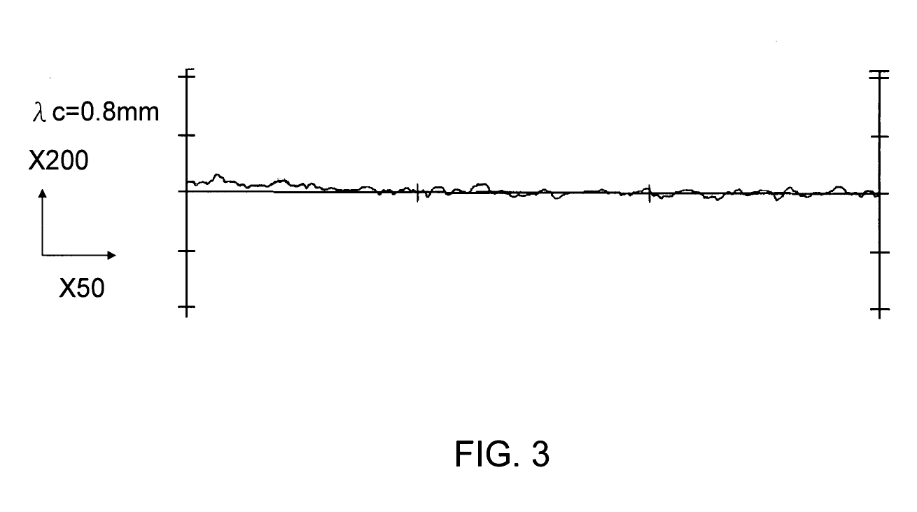

FIG. 2 is a cross-sectional photo of the mouse pad 10 according to an exemplary embodiment of the invention, which shows a rough surface area 11 and a pore area 13 of the surface layer 14. A surface roughness measurement instrument may be used to measure the surface roughness of the surface layer 14. FIG. 3 illustrates the surface roughness Ra of the surface layer 14 of an exemplary embodiment of the invention. The average of the Ra is between 1˜5 μm, which is within the reasonable range of surface roughness (a roughness within the range of 1˜20 μm is appropriate for mouse pads).

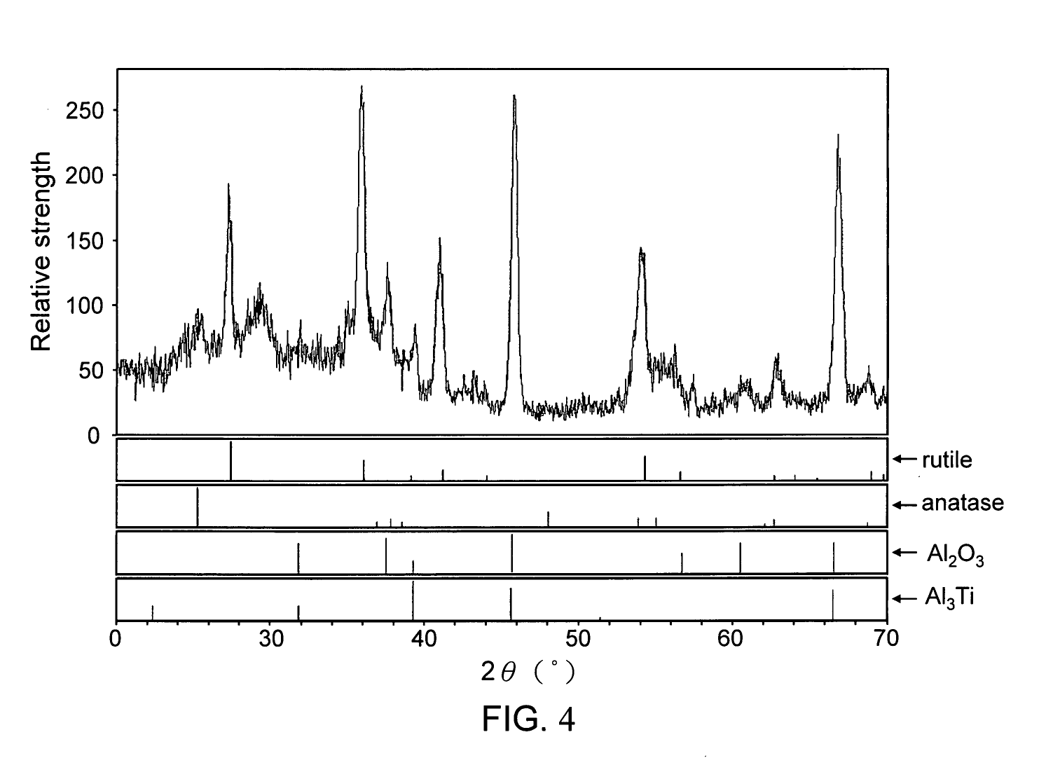

FIG. 4 depicts an X-Ray diffraction analysis of the surface layer 14 according to an exemplary embodiment of the invention. It shows that the surface layer 14 includes an anatase structure, a rutile structure, and an aluminum oxide (Al₂O₃) structure.

A performance test of the mouse pad according to an exemplary embodiment of the invention and a conventional mouse pad reveals the differences between them. First, a comparison of the conditions of the mouse pad before and after it is used shows that under the same situation, the mouse pad according to an exemplary embodiment of the invention appears cleaner than a conventional fabric mouse pad. Moreover, bacteria have grown on the conventional fabric mouse pad. Thus it shows that the mouse pad of the invention is dirt-resistant and anti-bacteria.

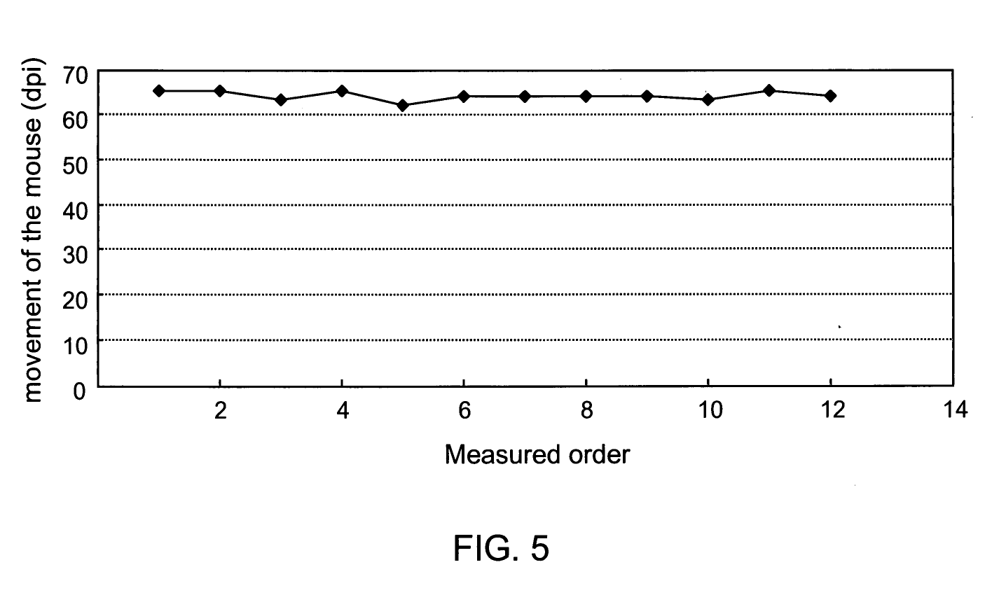

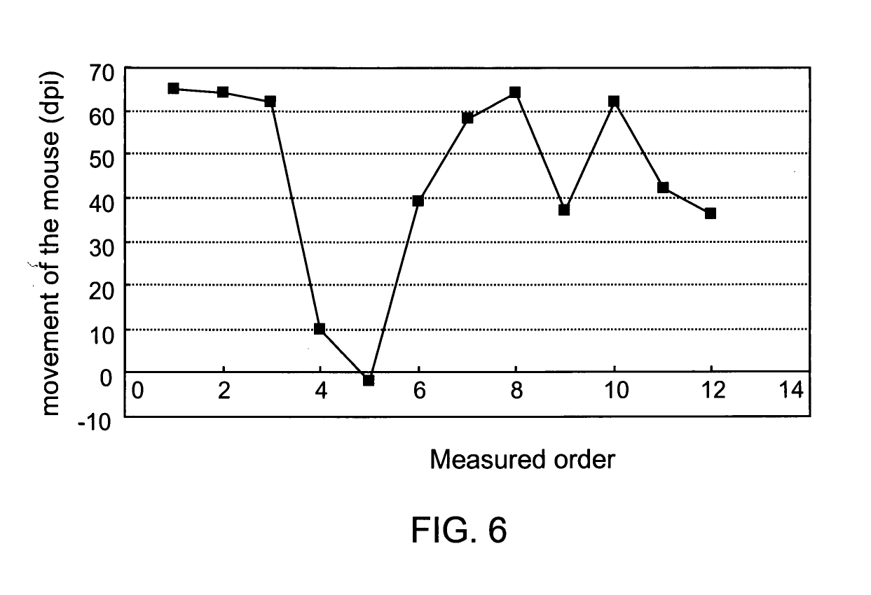

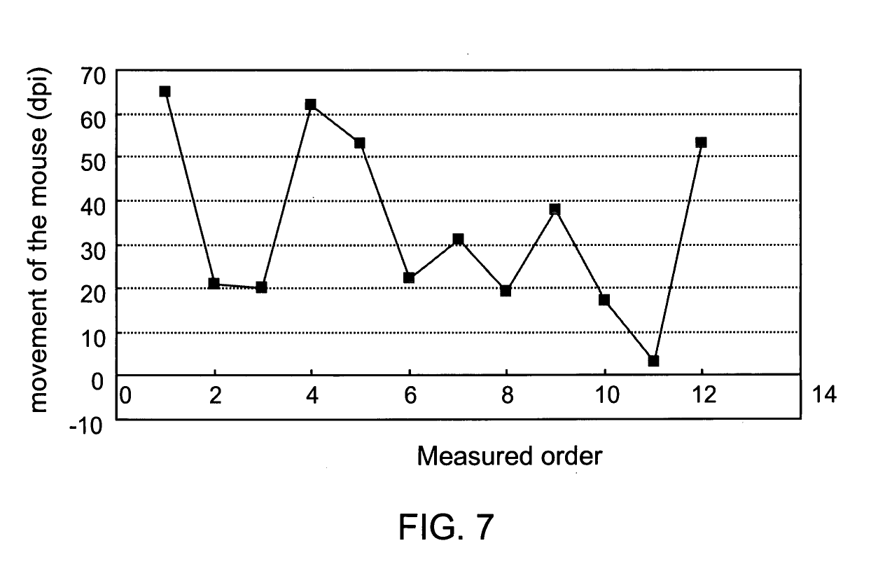

Further, as shown in FIG. 5-FIG. 7, a moving test is used for testing the stability of the mouse with a mouse pad of the invention, a fabric mouse pad, and a plastic mouse pad, wherein the stability refers to the degree to which the movement of the cursor is consistent with the movement of the mouse as the mouse is moving in horizontal and vertical directions. The result indicates that the movement of the cursor on the computer screen is very consistent with the movement of the mouse that is operated on a mouse pad according to an exemplary embodiment of the invention. The result also indicates that the movement of the mouse is very unstable when the mouse is used on the fabric mouse pad or the plastic mouse pad. It thus proves that the mouse pad according to an exemplary embodiment provides a greater precision for the mouse.

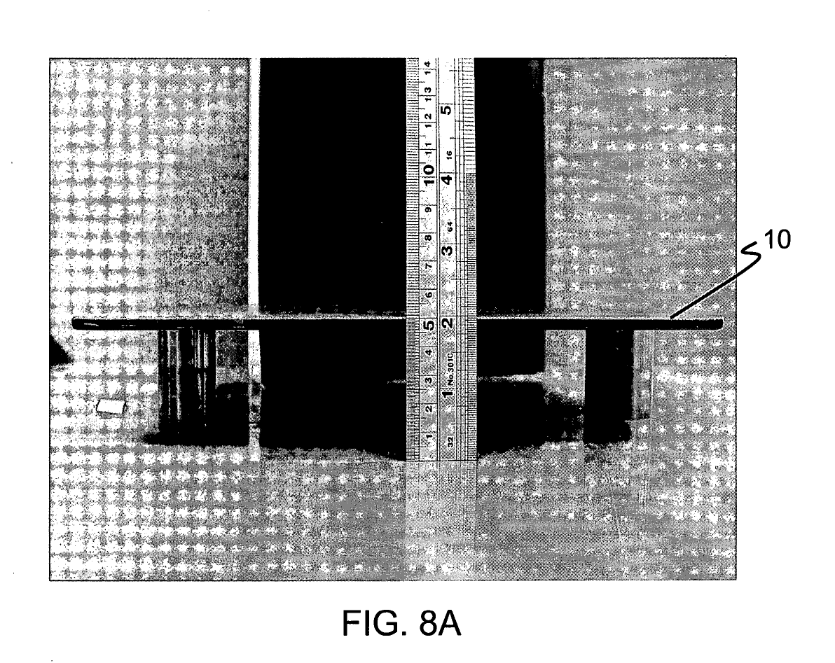

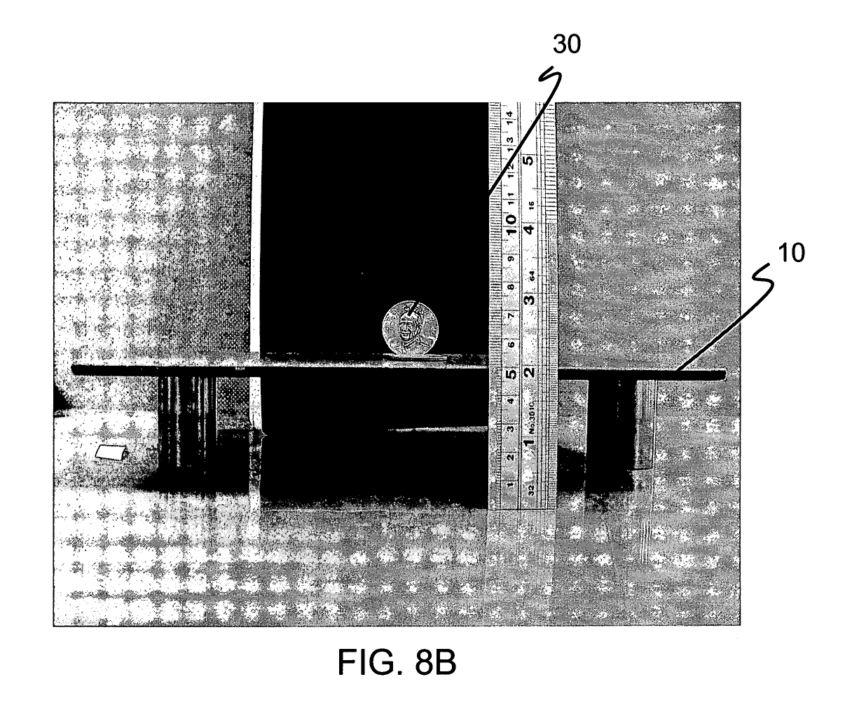

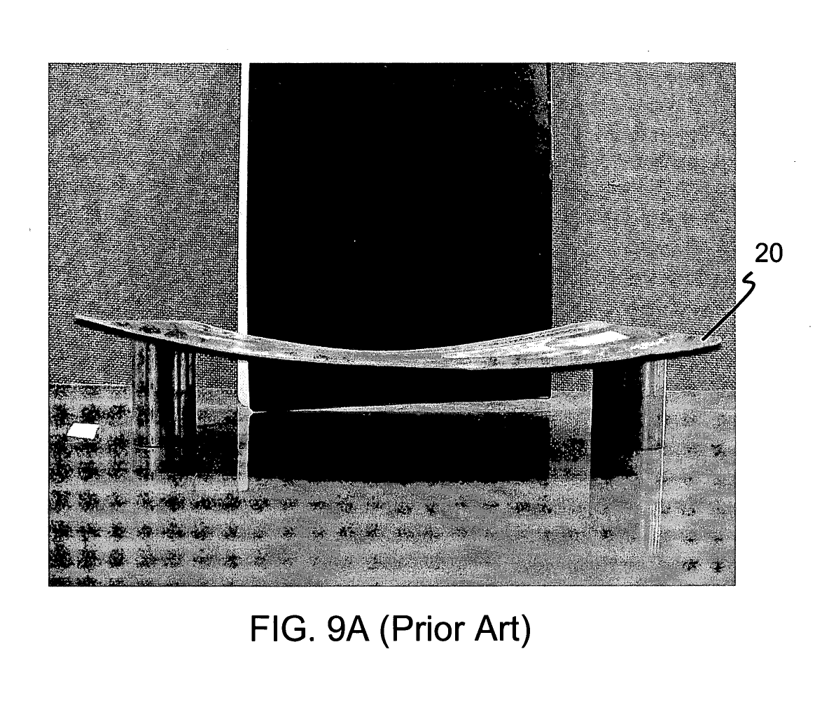

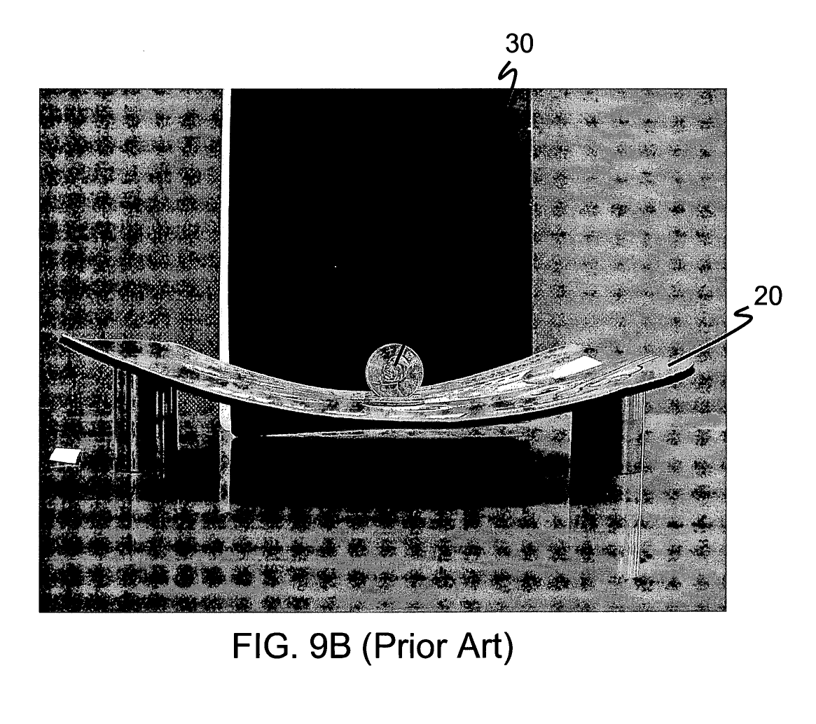

FIGS. 8A and 8B show the degree of deformity of the mouse pad 10 of the invention before and after the depression. FIGS. 9A and 9B show the degree of deformity of a plastic mouse pad 20 before and after the depression. Whether being depressed with coins 30 or not, the mouse pad 10 of the invention deforms to a less degree than the plastic mouse pad 20.

Table 1 presents the results of a test of the hardness of the materials used for different kinds of mouse pads, which show that the hardness of ceramic materials and glass materials are the highest among the materials tested. Ceramic materials and glass materials have a stronger abrasion-resistance, which may reduce scratches and therefore prolong the lifetime of the mouse pad and also help to maintain the sensitivity of the mouse.

TABLE 1

| material | ASTM D3363-92ahardness value |
|---|---|
| Ceramic material | >9H |
| Glass | >9H |
| 304 Stainless steel | 8H |
| Avional | 4H |
| Polymethyl methacrylate (PMMA) | 5H |
| Polycarbonate (PC) | F |
| Rubber | <F |

Table 2 presents the results of a test of mouse movement when the mouse is operated on mouse pads made from different materials and positioned at different angles. The results indicate that the mouse pad, made from a ceramic material, and the fabric mouse pad have smoother surfaces than mouse pads made from other materials. Further, as shown in Table 3, when the mouse pad made from a ceramic material and the fabric mouse pad are positioned at an angle of 10°, it takes less time for the mouse to move over a distance of 10 centimeters on the surface of the mouse pad made from a ceramic material than on the surface of the fabric mouse pad, which suggests that mice are most sensitive on the surface of mouse pads made from a ceramic material. It proves again that mouse pads made from a ceramic material according to an exemplary embodiment of the invention may help to improve the sensitivity of the mouse.

TABLE 2

angle of inclination

| | 8° | 12° | 14° | 16° | 18° | 20° |
|---|---|---|---|---|---|---|
| Ceramic surface | X | ◯ | ◯ | ◯ | ◯ | ◯ |
| Glass blasting | X | X | X | X | ◯ | ◯ |
| Plastic surface | X | X | X | ◯ | ◯ | ◯ |
| Fabric surface | X | ◯ | ◯ | ◯ | ◯ | ◯ |

TABLE 3

| | Time of movement | |
|---|---|---|
| Ceramic surface | 0.78 | second |
| Fabric surface | 1.95 | seconds |

Furthermore, a combustion test shows that mouse pads of the invention are safer because they are more combustion-resistant than conventional mouse pads. Further, the mouse pads of the invention have pores, and thus may absorb water and speed its evaporation. They are therefore particularly suitable for users whose hands tend to sweat.

In summary, mouse pads of the invention that are formed by coating a surface layer made from a ceramic material on a glass substrate, have a number of advantages. First, the surface roughness and surface shape of the mouse pads can be effectively controlled while maintaining the abrasion-resistant characteristic of the ceramic surface layer. Second, mouse pads of the invention will not deform even after being used for a long time. Third, mouse pads of the invention are less likely to get scratches because of the hardness of their ceramic surface layers, and can therefore be cleaned in many ways. Fourth, mouse pads of the invention may absorb water and speed its evaporation, and also feel good on touch, which is particularly comfortable for users whose hands tend to sweat. Fifth, a diversity of processes may be used to make mouse pads of the invention, which makes it easier to control the surface roughness and shape, and cleanness of the mouse pads, and makes it easier to control the appearance of the mouse pads and meet the quality standards for the mouse pads.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A mouse pad, comprising:
a glass substrate; and
a surface layer made from a ceramic material and formed on the glass substrate, wherein the surface layer has a plurality of pores with a surface roughness of 1˜20 μm.

2. The mouse pad of claim 1, wherein the glass substrate is a tempered glass board.

3. The mouse pad of claim 1, wherein the glass substrate is a crystallized glass board.

4. The mouse pad of claim 1, wherein the ceramic material includes an aluminum oxide at a concentration of 55˜95 wt % and a titanium oxide at a concentration of 5˜45 wt %.

5. The mouse pad of claim 1, wherein the ceramic material includes an aluminum oxide at a concentration of 55˜95 wt %, a titanium oxide at a concentration of 5˜45 wt %, and a copper at a concentration of 0.01˜3 wt %.

6. The mouse pad of claim 1, wherein the ceramic material includes an aluminum oxide at a concentration of 55˜95 wt %, a titanium oxide at a concentration of 5˜45 wt %, and a silver at a concentration of 0.01˜3 wt %.

7. The mouse pad of claim 1, wherein the ceramic material is selected from the group consisting of oxide, nitride, carbonide, and boride.

8. The mouse pad of claim 1, wherein the surface layer has a thickness ranging from 10˜100 m.

9. The mouse pad of claim 1, wherein the porous rate of the surface layer is within the range of 2˜15%.

10. The mouse pad of claim 1, wherein the surface layer is made from a composite material comprised of ceramic and metallic materials.

11. The mouse pad of claim 1, wherein the surface layer is formed on the glass substrate by means of the thermal spray deposition method.
